(19) United States
(12) Patent Application Publication
(10) Pub. No.: US 2024/0248241 A1
(43) Pub. Date: Jul. 25, 2024

(54) SPECTRAL FUNCTION-EQUIPPED IMAGING ELEMENT AND MANUFACTURING METHOD THEREFOR, MANUFACTURING METHOD FOR PIXELATED OPTICAL FILTER ARRAY, AND PRODUCT COMPRISING SPECTRAL FUNCTION-EQUIPPED IMAGING ELEMENT

(71) Applicant: TOHOKU UNIVERSITY, Sendai-shi, Miyagi (JP)

(72) Inventor: Yoshiaki KANAMORI, Sendai-shi, Miyagi (JP)

(73) Assignee: TOHOKU UNIVERSITY, Sendai-shi, Miyagi (JP)

(21) Appl. No.: 18/562,706

(22) PCT Filed: Sep. 3, 2021
(86) PCT No.: PCT/JP2021/032409

§ 371 Date: Nov. 20, 2023

(51) Int. Cl. G02B 5/20; G01J 3/28; G02B 5/26

(52) U.S. Cl. CPC G02B 5/201; G01J 3/2823; G02B 5/26; G01J 2003/2826

(57) ABSTRACT

Provided are a spectral function-equipped imaging element in which a plurality of spectral pixelated optical filters are incorporated, continuously in one direction of an imaging element without substantially influencing an imaging function of the imaging element, to enable acquisition of a spectrum of a target wavelength range, a manufacturing method therefor, and a manufacturing method for a pixelated optical filter array suitable as a spectral optical filter of such a spectral function-equipped imaging element.

### TECHNICAL FIELD

The present invention relates to a spectral function-equipped imaging element and a manufacturing method therefor, a manufacturing method for a pixelated optical filter array, a product incorporating a pixelated optical filter array, and a product including a spectral function-equipped imaging element.

### BACKGROUND ART

A spectrometer is a device that measures an energy intensity with respect to a wavelength of light. Recently, a field of use thereof is not limited to academic use and shows a sign of expanding widely from a daily life of people to industrial use. For example, information on freshness, sugar content, and the like can be acquired by acquiring a spectrum of fresh food using the spectrometer. It is also studied to use a spectrum of skin obtained using the spectrometer for cosmetic advice and to capture a state of an organ or tissue in a living body based on a spectrum obtained from the spectrometer mounted on an endoscope. In addition, by acquiring a spectrum of a product or a semi-finished product in a manufacturing process of processed food or an industrial product, a defective product that cannot be identified by a normal camera can be sorted out. Further, when mounted on a drone, an airplane, a satellite, or the like, the spectrometer can be used for a light environment investigation or the like in a wide region. When mounted on a wearable device, the spectrometer can acquire information on a light environment in which the device is located.

Thus, the spectrometer is expected to be applied in various fields.

A diffraction grating spectrometer is widely used as the spectrometer. For example, in a Czerny-Turner-type diffraction grating spectrometer, incident light passes through an incidence slit, then is reflected by a collimator mirror, and enters a diffraction grating. The light incident on the diffraction grating is resolved into wavelength components and detected by a photodetector. However, when the diffraction grating spectrometer is used, a certain space is required for diffraction of incident light, which limits size reduction. Meanwhile, there has been a demand for a smaller spectrometer that can be daily carried by people without a sense of resistance and that can also be mounted on a small precision device.

An imaging element is an element that converts an image into an electric signal. A CMOS image sensor or a CCD image sensor is used as the imaging element in a digital still camera or a digital video camera. Recently, due to need for a higher pixel resolution of the imaging element, there has been proposed a plurality of imaging apparatuses each using a multispectral sensor for a purpose of more accurately detecting a color component of a subject and improving color reproducibility by increasing types of wavelength bands to be subjected to spectroscopy (PTLS 1 to 3).

### CITATION LIST

### Patent Literature

PTL 1: JP2003-87806A
PTL 2: JP2012-44519A
PTL 3: JP2020-27980A

### SUMMARY OF INVENTION

### Technical Problem

PTL 1 proposes a technique using 16 types of color filters, but since a pixel array in an imaging element is not a Bayer array, a color image cannot be output as an actual output image. PTL 2 discloses an imaging element using a plurality of color filters each having a smaller bandwidth than bandwidths of each color of RGB in a Bayer array, but it is only possible to obtain information on 12 types of wavelength bands. PTL 3 proposes a technique in which two regions corresponding to a second color in a Bayer array including first, second, and third colors are made to have different spectral characteristics to increase types of wavelength bands from which information is acquired, thereby enabling finer spectroscopy, but it is still not possible to acquire sufficient information.

In order to implement a wide spread of the spectrometer, inventors of the present invention have come up with an idea that, in a small portable device in which an imaging element (image sensor) has already been incorporated, such as a smartphone or a digital camera, if a part of the sensor can be used as a spectrometer, the portable device can also have a spectral function without impairing an existing imaging function or influencing a size of the device. In the imaging element, even if a part of pixels are deficient, the deficiency is corrected by using an average value of data around the deficient portion as data of the deficient portion. Therefore, if a plurality of spectral pixelated optical filters covering an entire target wavelength range are continuously disposed in one direction of the imaging element at a level not substantially influencing the imaging function of the imaging element, it is possible to obtain a small device having the spectral function in addition to the existing imaging function. For example, when one row of a high resolution of 1980×1080 is allocated to the image sensor, the number of deficient pixels to be corrected due to the use as the spectrometer is only 1980 pixels out of about 2 million pixels, which is only about 0.09% of all of the pixels.

An object of the present invention is to provide a spectral function-equipped imaging element in which a spectral function is incorporated without impairing an imaging function or influencing a size of an imaging element, and a manufacturing method therefor. Another object of the present invention is to provide a manufacturing method for a pixelated optical filter array suitable as a spectral optical filter in the spectral function-equipped imaging element.

### Solution to Problem

The above objects of the present invention are implemented by the following methods.

[1]

A spectral function-equipped imaging element, in which a plurality of spectral pixelated optical filters are incorporated, continuously in one direction of an imaging element without substantially influencing an imaging function of the imaging element, to enable acquisition of a spectrum of a target wavelength range.

[2]

The spectral function-equipped imaging element according to [1], in which the plurality of spectral pixelated optical filters are incorporated, continuously in the one direction of the imaging element by replacing a part of pixelated color filters of the imaging element with the spectral pixelated optical filters, to enable the acquisition of the spectrum of the target wavelength range.

[3]

The spectral function-equipped imaging element according to [1] or [2], in which the target wavelength range at least includes a wavelength range of 400 nm to 700 nm.

[4]

The spectral function-equipped imaging element according to any one of [1] to [3], in which each transmitted light wavelength of the plurality of spectral pixelated optical filters continuously disposed in the one direction is continuously shifted from one end to the other end in the one direction from a short wavelength side to a long wavelength side.

[5]

The spectral function-equipped imaging element according to [4], in which each of the plurality of spectral pixelated optical filters continuously disposed in the one direction has a reflective layer A, an optical waveguide layer on the reflective layer A, and a reflective layer B on the optical waveguide layer, the plurality of spectral pixelated optical filters are continuously disposed in the one direction, and a thickness of the optical waveguide layer continuously increases from the one end to the other end in the one direction.

[6]

The spectral function-equipped imaging element according to [5], in which the reflective layer A and/or the reflective layer B is a layer containing a metal.

[7]

The spectral function-equipped imaging element according to any one of [1] to [6], in which the spectral pixelated optical filters are not adjacent to each other in a plan view of the spectral function-equipped imaging element from a side where the plurality of spectral pixelated optical filters are disposed.

[8]

A manufacturing method for a spectral pixelated optical filter array, the method including:
forming a reflective layer A on a transparent substrate, then disposing a mask above the reflective layer A at an interval from a surface of the reflective layer A and sputtering an optical waveguide layer forming material toward the surface of the reflective layer A, thereby forming, on the reflective layer A, an optical waveguide layer having an inclined portion whose thickness continuously increases toward one direction, and then forming a reflective layer B on the optical waveguide layer, thereby obtaining a film thickness gradient optical filter;
forming a photoresist film on the reflective layer B, then masking the photoresist film on the inclined portion corresponding to portions where a plurality of pixelated optical filters are to be formed, then exposing the photoresist film, and then removing the photoresist film of a portion not masked during the masking;
scraping off the film thickness gradient optical filter corresponding to the portion where the photoresist film is removed; and
removing the remaining photoresist film to obtain a spectral pixelated optical filter array in which a transmitted light wavelength is shifted from one end toward the other end in the one direction stepwise from a short wavelength side to a long wavelength side.
   [9]

The manufacturing method for a spectral pixelated optical filter array according to [8], in which spectral pixelated optical filters constituting the spectral pixelated optical filter array are not adjacent to each other in a plan view.

A manufacturing method for the spectral function-equipped imaging element according to any one of [1] to [7], the method including: incorporating, in an imaging element, a pixelated optical filter array obtained by the manufacturing method for a spectral pixelated optical filter array according to [8] or [9].

A product including: the spectral function-equipped imaging element according to any one of [1] to [7].

### Advantageous Effects of Invention

According to the present invention, it is possible to provide a spectral function-equipped imaging element in which a spectral function is incorporated without impairing an imaging function or influencing a size of an imaging element, and a manufacturing method therefor. Further, the spectral function-equipped imaging element disclosed in the present: invention can greatly increase the number of wavelength divisions almost continuously and can obtain fine spectral data as well as prevent an obtained image from being coarse. In addition, according to the present invention, there is provided a manufacturing method for a pixelated optical filter array suitable as a spectral optical filter in the spectral function-equipped imaging element.

### BRIEF DESCRIPTION OF DRAWINGS

FIG. 1 is an explanatory diagram showing an example of a spectral principle based on incorporation of a spectral pixelated optical filter into an imaging element.

FIG. 2 is an explanatory diagram showing a mechanism configured to correct deficiency caused by incorporation of a spectral pixelated color filter.

FIG. 3 is schematic diagrams showing an embodiment of a spectral pixelated optical filter array.

FIG. 4 is explanatory diagrams schematically showing an example of a process from preparation of a film thickness gradient optical filter to pixelation.

FIG. 5 is an explanatory diagram (schematic cross-sectional view) showing an example in which the number of sputtering atoms reaching a surface of an Ag film can be controlled by disposing a mask.

FIG. 6 shows an example of a photograph observed from a SiO₂ substrate side of a film thickness gradient filter prepared in Example.

FIG. 7 shows a transmission spectrum of the film thickness gradient filter prepared in Example when moved by 320 μm at a time in a direction in which a film thickness increases.

FIG. 8 is a graph showing an approximately straight line obtained by a least squares method with a vertical axis representing a peak wavelength and a horizontal axis representing a position (at an interval of 320 μm) where the peak wavelength is observed with respect to the transmission spectrum shown in FIG. 7. A coefficient of determination R² at that time is also shown.

FIG. 9 shows an example of disposition in a pixel region of a photomask adopted in Example.

FIG. 10 is a photograph showing a method for evaluating a spectral pixelated optical filter array in Example.

FIG. 11 shows a transmission spectrum of the film thickness gradient filter prepared in Example when moved by 50 μm at a time in the direction in which the film thickness increases.

### DESCRIPTION OF EMBODIMENTS

### [Spectral Function-Equipped Imaging Element]

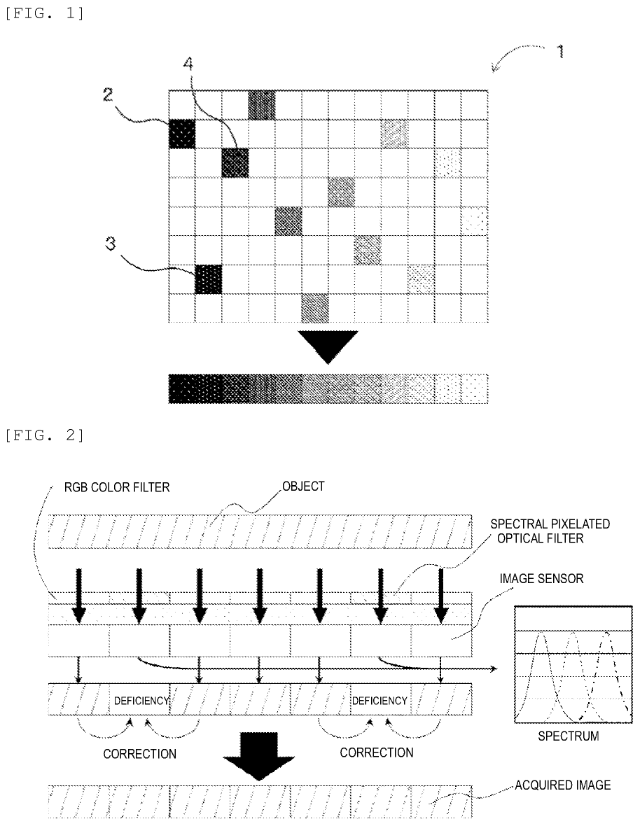

A spectral function-equipped imaging element (spectral function-equipped image sensor) according to the present invention has a structure in which a plurality of spectral pixelated optical filters are incorporated, continuously in one direction of an imaging element without substantially influencing an imaging function of the imaging element, to enable acquisition of a spectrum of a target wavelength range. The expression “a plurality of spectral pixelated optical filters are incorporated, continuously in one direction of an imaging element, to enable acquisition of a spectrum of a target wavelength range” means that it is not necessary to dispose the plurality of spectral pixelated optical filters linearly in the one direction, and, when the imaging element is viewed from a side with attention to disposition of only the spectral pixelated optical filters, the plurality of spectral pixelated optical filters are continuously disposed to enable the acquisition of the spectrum of the target wavelength range in a side view from one side. This state will be described with reference to FIG. 1. FIG. 1 is merely an explanatory diagram of a spectral principle based on incorporation of a pixelated spectral filter into an imaging element, and the present invention is not to be construed as being limited in any way by the case in FIG. 1 except for those defined in the present invention. Further, the term “continuously” can be explained in the following equation.

$$y = aX + b$$

Here, y represents a peak transmission wavelength of a spectral pixelated optical filter, X represents an optional position (length, for example, represented in terms of μm) in a direction in which a thickness increases from a starting point where a thickness of the spectral pixelated optical filter starts to increase, a represents a coefficient, and b represents the peak transmission wavelength of the spectral pixelated optical filter when X is zero. A specific example will be described later with reference to FIG. 8.

FIG. 1 is a schematic diagram showing spectroscopy with the pixelated spectral filter. FIG. 1 shows pixels (8 vertical×12 horizontal) constituting an imaging element 1. A spectral pixelated optical filter 2, which selectively transmits light having a shortest wavelength among all spectral pixelated optical filters disposed in the imaging element 1, is disposed in a pixel in a first column from the left in a second row from the top in the imaging element 1 in FIG. 1. In addition, a spectral pixelated optical filter 3, which selectively transmits light having a longer wavelength than the spectral pixelated optical filter 2, is disposed in a second column in a second row from the bottom. A spectral pixelated optical filter 4, which selectively transmits light having a longer wavelength than the spectral pixelated optical filter 3, is disposed in a third column in a third row from the top. Thus, each time the column moves from a left one to a right one, only one spectral pixelated optical filter that selectively transmits light having a longer wavelength is disposed therein. That is, in a side view seen from above in FIG. 1 (the same applies to a side view seen from below), a plurality of spectral pixelated optical filters are continuously disposed in a horizontal direction in FIG. 1. It is possible to obtain a spectrum over an entire desired wavelength range by aggregating data collected through the pixels provided with these spectral pixelated optical filters as data of one row as shown in a lower portion in FIG. 1.

The plurality of spectral pixelated optical filters may also be disposed intermittently in one direction as long as an objective effect is not impaired. For example, in FIG. 1, the spectral pixelated optical filters may be disposed in every other column (for example, one spectral pixelated optical filter may be disposed every two columns). In this case, it is still possible to acquire the spectrum of the desired wavelength range, and this case is included in the case where “a plurality of spectral pixelated optical filters are incorporated” “continuously in one direction of an imaging element” defined in the present invention.

The plurality of spectral pixelated optical filters continuously disposed in the one direction can typically be configured such that each transmitted light wavelength of the spectral pixelated optical filters continuously shifts from one end to the other end in the one direction from a short wavelength side (or a long wavelength side) to a long wavelength side (or a short wavelength side). However, the present invention is not limited to such a case except for those defined in the present invention. Arrangement of the transmitted light wavelengths of the plurality of spectral pixelated optical filters is not particularly limited as long as an energy intensity for each wavelength in the entire target wavelength range is obtained when data of one row or data of one column is aggregated. For example, transmitted light wavelengths of spectral pixelated optical filters disposed in “first row, second row, third row, fourth row, . . . ” in FIG. 1 may be shifted continuously from a short wavelength side to a long wavelength side, such as “400 nm, 410 nm, 420 nm, 430 nm, . . . ”, respectively, or may be arranged randomly such as “410 nm, 430 nm, 400 nm, 420 nm, . . . ”. In short, it is only required that the plurality of spectral pixelated optical filters covering the desired wavelength range are continuously incorporated in the one direction.

FIG. 1 is an explanatory diagram for promoting understanding of the present invention, and an actual imaging element usually includes significantly more pixels than that shown in FIG. 1. For example, since a Full HD resolution (number of pixels) is 1980×1080, theoretically, 1980 spectral pixelated optical filters can be disposed in one row.

In the spectral function-equipped imaging element according to the present invention, the spectral pixelated optical filters are disposed without substantially influencing an imaging function of the imaging element. The expression “without substantially influencing an imaging function” means that an influence of deficient pixels is not recognized when an image obtained by the imaging element is visually observed. That is, in order to eliminate the influence of the deficient pixels on the image, it is preferable that the imaging element is designed such that the deficient pixels of the imaging element caused by the spectral pixelated optical filters are correctable by data around the deficient pixels. More specifically, it is preferable that the deficient pixels can be corrected by using an average value of the data around the deficient pixels as data of the deficient pixels, and as a result, the imaging element is designed such that the influence of the deficient pixels is not recognized when the image obtained by the imaging element is visually observed.

In order to enable the correction by the data around the deficient pixels, in a plan view (FIG. 1 corresponds to this plan view) from a side on which the spectral pixelated optical filters are disposed, the spectral pixelated optical filters can be disposed in a manner not adjacent to (not continuous with) each other. That is, disposition shown in FIG. 1 is adopted. By disposing the spectral pixelated optical filters such that the deficient pixels of the imaging element are not adjacent to each other, the deficient pixels can be more reliably corrected. In the present invention, the expression “spectral pixelated optical filters are not adjacent to each other” means that the spectral pixelated optical filters are not in contact with each other in a vertical direction and a horizontal direction (a column direction and a row direction in FIG. 1) of the arrangement of the pixels. Further, it is preferable that the spectral pixelated optical filters are not in contact with each other also in an oblique direction (a diagonal line direction of the pixels).

In other words, the expression “without substantially influencing an imaging function” means that the imaging function of the imaging element is at a level at which, for example, a function imparted to a digital camera or a camera of a smartphone, autofocus, white balance, zoom, a format of a saved image, and a size (deficiency of pixels on an image due to the imparting of the spectral function) are not impaired.

FIG. 2 schematically shows an overview of a mechanism configured to correct deficiency caused by incorporation of a spectral color filter. Light (including reflected light) emitted from an object passes through an RGB color filter and is incident on a color imaging element (color image sensor) to form an image. A part of pixels of the RGB color filter are replaced with spectral color filters, and RGB information of this portion is corrected by, for example, an average value of data of surrounding pixels.

The imaging element constituting the spectral function-equipped imaging element according to the present invention may be a color imaging element including a color filter or a monochrome (white and black) imaging element including no color filter. In a case where spectral pixelated optical filters are incorporated in a color imaging element in which color filters such as RGB color filters are disposed on pixels of a sensor, a part of the color filters on the pixels are replaced with the spectral pixelated optical filters. In a case of the monochrome imaging element including no color filter, the spectral pixelated optical filters can be disposed in a part of pixels of the monochrome imaging element.

In the spectral function-equipped imaging element according to the present invention, a wavelength range of an acquirable spectrum is appropriately set according to a purpose. For example, when it is desired to obtain a spectrum in a visible light range, for example, the spectral pixelated optical filters can be continuously incorporated in one direction on pixels of the imaging element to cover at least a wavelength range of 400 nm to 700 nm. When it is desired to obtain light energy information from a near-ultraviolet range to a near-infrared range, for example, the spectral pixelated optical filters can be incorporated to cover a wavelength range of 350 nm to 1100 nm. This wavelength range can be appropriately set within a detectable wavelength range in consideration of quantum efficiency or the like of the imaging element. Therefore, it is also possible to adopt a configuration having a spectral function specialized in a limited wavelength range within the above wavelength range.

In the spectral function-equipped imaging element according to the present invention, in the plurality of spectral pixelated optical filters continuously incorporated in the one direction, a difference in transmitted light wavelength between the spectral pixelated optical filters adjacent to each other in the one direction is preferably 20 nm or less, more preferably 10 nm or less, still more preferably 5 nm or less, yet still more preferably 4 nm or less, particularly preferably 3 nm or less, and more particularly preferably 2 nm or less.

The spectral pixelated optical filters used in the present invention can be obtained by individually preparing a pixelated filter for each wavelength. It is also possible to prepare a film thickness gradient optical filter with a Fabry-Perot structure, pixelate the film thickness gradient optical filter, and incorporate the film thickness gradient optical filter into the imaging element as a spectral pixelated optical filter array. For the Fabry-Perot structure, see, for example, ACS Photonics, Vo. 2, pp. 183-188, (2015). In consideration of manufacturing efficiency and mass production, it is preferable to apply a spectral pixelated optical filter array as the spectral pixelated optical filters. The spectral pixelated optical filter array will be described below.

### <Spectral Pixelated Optical Filter Array>

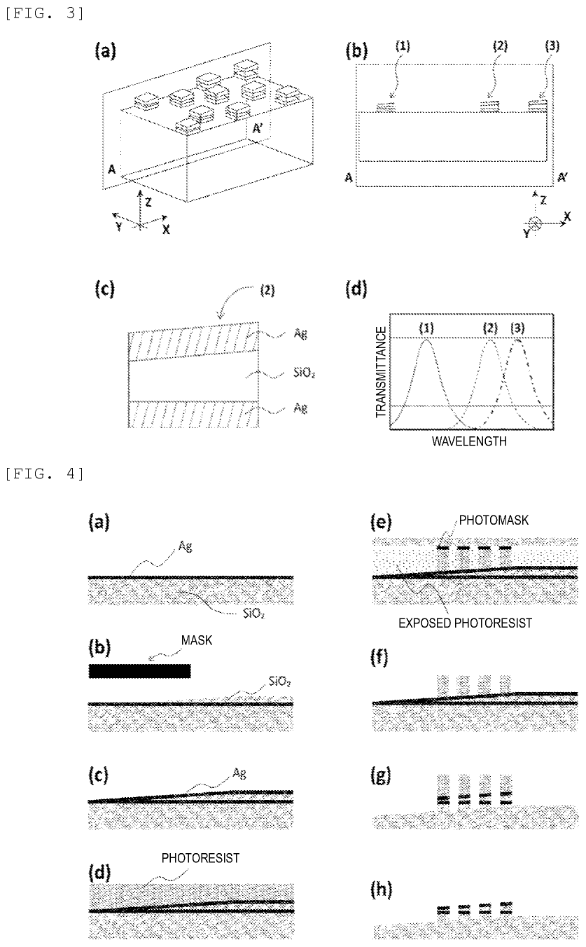

FIG. 3 is schematic diagrams showing a spectral pixelated optical filter array. (a) of FIG. 3 shows a three-dimensional view, (b) of FIG. 3 shows a cross sectional view taken along plane A-A′ in (a) of FIG. 3 and pixelated portions (1) to (3), and (c) of FIG. 3 shows an enlarged view of the pixelated portion (2). An interferometer using an optical system with two reflective mirrors (reflective layers) as shown in (c) of FIG. 3 is called a Fabry-Perot interferometer, and a structure of this optical system is called a Fabry-Perot structure. (a) to (d) of FIG. 3 show a three-layer Fabry-Perot structure using silver (Ag) films as the two reflective mirrors and silicon dioxide (SiO₂) as an optical waveguide layer. The Fabry-Perot structure allows a transmission wavelength to be controlled by an interval between the reflective mirrors. In a film thickness gradient optical filter in which the interval between the reflective mirrors is linearly changed, when an inclination direction is an X-axis and an in-plane direction perpendicular to the inclination direction is a Y-axis, a light transmission wavelength in the X-axis direction linearly changes and a light transmission characteristic in the Y-axis direction is constant. Therefore, a spectral pixelated optical filter array obtained by pixelating a film thickness gradient optical filter exhibits light transmission characteristics corresponding to positions of the pixelated portions (1) to (3), as shown in (d) of FIG. 3. Therefore, when all pixels in (a) of FIG. 3 are synthesized, a filter that transmits different wavelengths stepwise is obtained, which can function as a spectral filter.

A constituent material of the reflective mirror is not particularly limited as long as a function as a reflective mirror is obtained. Generally, a film made of a material containing a metal (preferably a metal or an alloy) is used as the reflective mirror. Examples of the metal constituting the metal or the alloy include silver (Ag), aluminum (Al), and gold (Au). A multilayer mirror or a photonic crystal containing no metal may also be used as the reflective mirror.

A constituent material of the optical waveguide layer is not particularly limited as long as optical transmittance is exhibited. Examples thereof include silicon dioxide (SiO₂), hafnium oxide (HfO₂), and resins (for example, acrylic resin, polystyrene resin, polycarbonate resin, and polyolefin resin).

FIG. 4 is schematic side views showing a process from preparation of the film thickness gradient optical filter to pixelation in manufacturing of the spectral pixelated optical filter array. FIG. 4 shows a case where the reflective mirror is an Ag film and the optical waveguide layer is a SiO₂ film, and, in the present invention, a material for forming the spectral pixelated optical filter array is not limited thereto as described above.

(a) of FIG. 4 shows a process of forming the reflective mirror made of the Ag film by sputtering Ag on a SiO₂ substrate. A thickness of the SiO₂ substrate is appropriately set according to a purpose. For example, the thickness may be 10 nm to 1000 nm. A thickness of the reflective mirror can also be appropriately set according to the purpose and can be, for example, 5 nm to 100 nm.

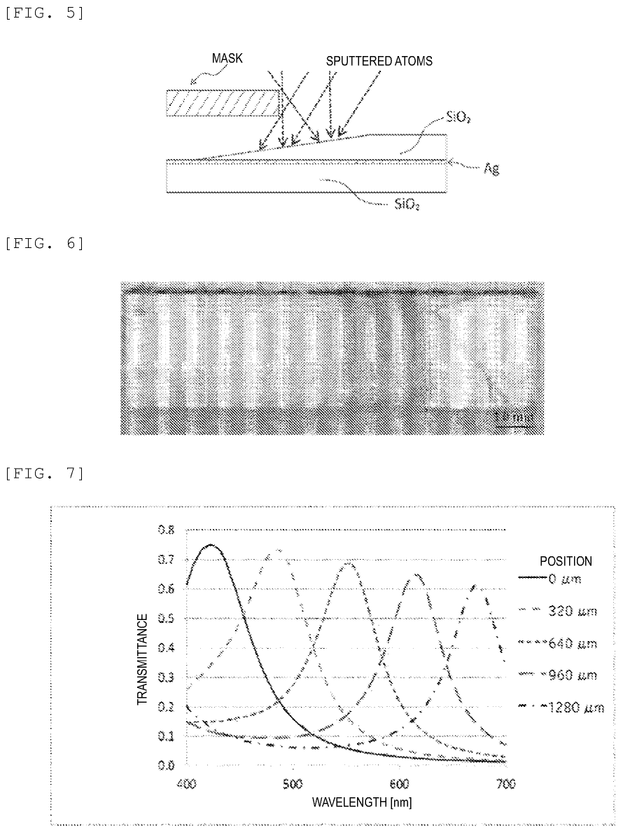

In (b) of FIG. 4, a mask is disposed at an interval above the Ag film formed in (a) of FIG. 4, and SiO₂ is sputtered toward a surface of the Ag film to form an optical waveguide layer made of a SiO₂ film on the Ag film. When SiO₂ is sputtered, presence of the mask makes it difficult for sputtered atoms to reach a portion below the mask (see FIG. 5). Therefore, due to the disposition of the mask, the number of sputtered atoms reaching the surface of the Ag film can be controlled, and a SiO₂ inclined film can be formed as shown in (b) of FIG. 4 and FIG. 5. Since an inclination angle and an inclination width of the SiO₂ inclined film can be controlled by the interval between the Ag film and the mask, it is possible to freely form any inclination from a gentle and long inclination to a steep and narrow inclination.

(c) of FIG. 4 shows a process of forming a reflective mirror made of an Ag film by sputtering Ag on the SiO₂ film formed in (b) of FIG. 4. Accordingly, a film thickness gradient optical filter can be obtained. A thickness of the reflective mirror can also be appropriately set according to the purpose and can be, for example, 5 nm to 100 nm.

A maximum film thickness of the film thickness gradient optical filter can be designed according to a desired transmitted light wavelength. For example, since a thickness of a SiO₂ film (optical waveguide layer) that enables transmission in a visible light range of 400 nm to 700 nm is 75 nm to 185 nm, the maximum film thickness in the sputtering is 185 nm or more in order to cover the visible light range.

The film thickness gradient optical filter is subjected to a pixelation process to be described later.

(d) of FIG. 4 shows a process of applying, by spin coating or the like, a photoresist onto the film thickness gradient optical filter obtained in (c) of FIG. 4. As the photoresist, an existing photoresist used for forming a fine pattern can be appropriately applied.

(e) of FIG. 4 shows a process of aligning a photomask with the photoresist formed in (d) of FIG. 4 in a desired pixel region and exposing a portion other than the pixel region.

(f) of FIG. 4 shows a process of removing the photoresist exposed in (e) of FIG. 4 by using an alkaline developer. As the alkaline developer, a developer generally used for removing a photoresist can be applied, and for example, a tetramethylammonium hydroxide (TMAH) aqueous solution can be used. After the treatment with the alkaline developer, it is preferable to perform pure cleaning and drying.

(g) of FIG. 4 shows a process of removing (scraping off) the portion (non-pixelated region), from which the photoresist is removed, of the film thickness gradient optical filter by milling after the photoresist is removed in (f) of FIG. 4. In general, ion beam milling is used.

(h) of FIG. 4 shows a process of removing the photoresist remaining in a pixelated region after removing the non-pixelated region from the film thickness gradient optical filter in (g) of FIG. 4. Depending on a type of the photoresist, the photoresist can be removed by, for example, immersing in a solvent such as acetone. After the photoresist is removed, if necessary, the filter is rinsed with an alcohol (for example, isopropanol) or the like and dried to obtain a spectral pixelated optical filter array.

(a) to (h) of FIG. 4 show an array configuration in which the spectral pixelated optical filters are disposed in a row in the horizontal direction for convenience of explanation, and the disposition of the spectral pixelated optical filters in the spectral pixelated optical filter array can be appropriately designed by controlling the disposition of the mask during the SiO₂ sputtering and the disposition of the photomask on the photoresist.

That is, according to the present invention, the following manufacturing method for a spectral pixelated optical filter array is provided.

A manufacturing method for a spectral pixelated optical filter array, the method including:
forming a reflective layer A on a transparent substrate, then disposing a mask above the reflective layer A at an interval from a surface of the reflective layer A and sputtering an optical waveguide layer forming material toward the surface of the reflective layer A, thereby forming, on the reflective layer A, an optical waveguide layer having an inclined portion whose thickness continuously increases toward one direction, and then forming a reflective layer B on the optical waveguide layer, thereby obtaining a film thickness gradient optical filter;
forming a photoresist film on the reflective layer B, then masking the photoresist film on the inclined portion corresponding to portions where a plurality of pixelated optical filters are to be formed, then exposing the photoresist film, and then removing the photoresist film of a portion not masked during the masking;
scraping off the film thickness gradient optical filter corresponding to the portion where the photoresist film is removed; and
removing the remaining photoresist film to obtain a spectral pixelated optical filter array in which a transmitted light wavelength is shifted from one end toward the other end in the one direction stepwise from a short wavelength side to a long wavelength side.

In the spectral pixelated optical filter array or the manufacturing method therefor, the transparent substrate and the reflective layer A, the reflective layer A and the optical waveguide layer, and the optical waveguide layer and the reflective layer B may be in direct contact with each other or may be in contact with each other via another layer such as an adhesion layer (for example, a layer made of chromium or titanium). A protective film or the like that transmits visible light may also be provided on a surface of the reflective mirror B.

By incorporating the spectral pixelated optical filter array obtained as described above into the imaging element, the spectral function-equipped imaging element according to the present invention can be obtained.

### Example

The present invention will be described in more detail based on Example, but the present invention is not limited to Example except for those defined in the present invention.

### Preparation of Film Thickness Gradient Optical Filter

A SiO₂ substrate of 9 mm length×2.5 mm width×0.5 mm thickness was prepared, and an inclined film having a three-layer structure including an Ag film (reflective mirror A), a SiO₂ inclined film (optical waveguide layer), and an Ag film (reflective mirror B) was formed on the substrate to prepare a film thickness gradient optical filter covering a wavelength range of 400 nm to 700 nm, which is a visible light range. A size of the SiO₂ substrate was determined in consideration of a size of a sensor S10420-1006-01 manufactured by Hamamatsu Photonics K.K., which is an existing imaging element. A specific preparation method will be described later.

A thickness of the optical waveguide layer, which has a Fabry-Perot structure transmitting light in the visible light range of 400 nm to 700 nm, is 75 nm to 185 nm. By forming the SiO₂ inclined film having a thickness in this thickness range, a film thickness gradient optical filter covering the visible light range of 400 nm to 700 nm can be obtained. Then, a SiO₂ inclined film (length: 2.6 mm) having a maximum film thickness of 280 nm, which is sufficiently larger than 185 nm, was formed. Each of the two Ag films sandwiching the optical waveguide layer had a thickness of 30 nm.

First, the film thickness gradient optical filter was obtained through the processes shown in (a) to (c) of FIG. 4.

### <Formation of Ag Film>

The SiO₂ substrate was subjected to ultrasonic cleaning with ethanol, and Ag was sputtered using a sputtering apparatus QUICKCOATER (SC-701HMCII) manufactured by Sanyu Electron Co., Ltd. to form an Ag film having a film thickness of 30 nm on the SiO₂ substrate ((a) of FIG. 4).

### <Formation of SiO₂ Inclined Film>

A mask having a thickness of 1 mm (material: SS 400) was set above a surface of the Ag film at a certain distance from the surface of the Ag film, and SiO₂ was sputtered using an RF magnetron Sputter CFS-4ES manufactured by Shibaura Mechatronics Corporation to form a SiO₂ inclined film having a film thickness of 280 nm on the Ag film ((b) of FIG. 4).

### <Formation of Ag Film>

Ag was sputtered using a sputtering apparatus QUICKCOATER (SC-701HMCII) manufactured by Sanyu Electron Co., Ltd. to form an Ag film having a film thickness of 30 nm on the SiO₂ inclined film ((c) of FIG. 4).

Thus, a film thickness gradient optical filter was obtained.

FIG. 6 shows a state in which the obtained film thickness gradient filter is observed from the SiO₂ substrate side. In the above <Formation of SiO₂ Inclined Film>, the mask was disposed above a left half in FIG. 6 during the SiO₂ sputtering. It is found that a color changes (in a spectral manner) as the film thickness increases from a left side where the mask is disposed to a right side.

### [Evaluation of Film Thickness Gradient Optical Filter]

A film thickness gradient filter obtained in the same manner as described above except that the size of the SiO₂ substrate was 2 cm square was subjected to a transmission measurement using a microspectrometer from the SiO₂ substrate side in a wavelength range of 400 nm to 700 nm. An angle of a color stripe was visually checked, the filter was moved perpendicularly to the color stripe visually checked each time the transmission measurement was performed, and a change in a spectrum of a transmission characteristic depending on a position was examined.

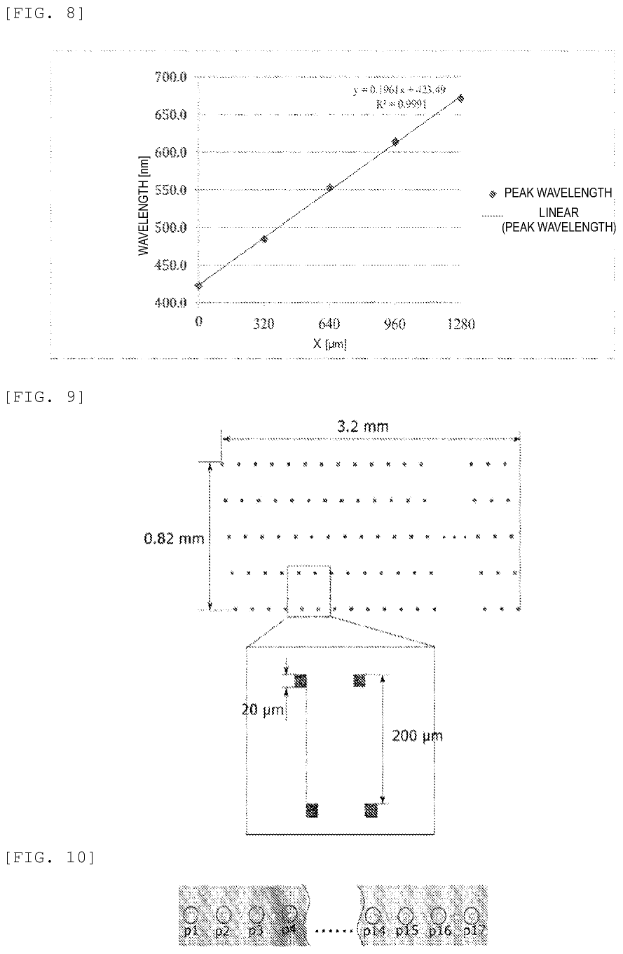

FIG. 7 shows a transmission spectrum for each movement of 320 μm in a direction in which the film thickness increases (corresponding to X (μm) in FIG. 8). FIG. 8 shows an approximately straight line obtained by obtaining a peak wavelength of the spectrum (peak transmission wavelength y at X) and a coordinate of the X (x-axis) by a least squares method, and a determination coefficient R² at that time. As shown in FIG. 7, it is found that the spectrum transitions depending on the position of the film thickness gradient optical filter. As shown in FIG. 8, R²=0.9991, which shows a graph having high linearity. That is, it is found that a change in the peak wavelength is linear.

As described above, the spectral function-equipped imaging element according to the present invention can greatly increase the number of wavelength divisions and thus can obtain fine spectral data as well as prevent an obtained image from being coarse. In other words, in the above description, the structure in which “a plurality of spectral pixelated optical filters are incorporated, continuously in one direction of an imaging element, to enable acquisition of a spectrum of a target wavelength range” is provided.

In other words, for example, in the technique in PTL 3, a wavelength of visible light can be divided into 16 divisions at maximum, and, in the present invention, the wavelength can be divided into more than 16 divisions.

In the present invention, the number of wavelength divisions depends on a maximum number of pixels in one direction of the imaging element, but is not limited. For example, when the number of pixels in one direction is N pixels (N: integer), the wavelength of the visible light can at least be divided into 20 or more divisions, preferably 20 to N divisions, more preferably 30 to N×0.8 divisions. N is in a range of 50 to 8000. By dividing N into 20 or more divisions, a clearer image can be obtained.

At most, the wavelength can be divided by a larger number among the number of pixels in a horizontal row and the number of pixels in a vertical column of the imaging element. For example, in a case of a 4K compatible imaging element, the wavelength can be divided into about 8000 (4000×2) divisions since there are about 4000 pixels horizontally and one pixel is composed of 2×2 subpixels. Therefore, the number of types of wavelength bands can be obtained is increased, and spectral data that is significantly finer than that in the technique in PTL 3 can be obtained. In the technique in PTL 3, since each subpixel of RGB is further divided into four divisions, one pixel usually includes 4 (2×2) subpixels, and thus 16 (4×4) subpixels are required for one pixel. For example, even when the technique in PTL 3 is applied to a 4K compatible imaging element, an image having a resolution corresponding to only 2K is obtained, and thus an obtained image is coarse. However, when the spectral function-equipped imaging element according to the present invention is applied to the 4K compatible imaging element, an image having a resolution corresponding to 4K can be obtained, and the image is not coarse.

In the film thickness gradient optical filter formed on the 2 cm square substrate, the distance X corresponding to a range from a peak transmission wavelength of 400 nm to a peak transmission wavelength of 700 nm and having an effective spectral function was 1600 μm. Based on a correlation between the peak wavelength and the distance X, a spectral function-equipped imaging element having a peak wavelength outside the range of 400 nm to 700 nm can be designed and manufactured.

### Preparation of Spectral Pixelated Optical Filter Array

The film thickness gradient optical filter (SiO₂ substrate×2.5 mm width×0.5 mm thickness) obtained in [Preparation of Film Thickness Gradient Optical Filter] described above was subjected to the pixelation process in (d) to (h) of FIG. 4 to obtain a spectral pixelated optical filter array.

### <Formation of Photoresist Film>

Since an apparatus used in the process herein was not suitable for a small substrate of less than 2 cm square, a 2 cm square glass substrate was spin-coated with a photoresist OFPR-800LB-200cp at 3000 rpm for 20 seconds, and the film thickness gradient optical filter was placed thereon and baked at 90° C. in an oven for 60 minutes. Thus, the film thickness gradient optical filter was attached to the 2 cm square glass substrate. In this process, the photoresist OFPR-800LB-200cp is used as an adhesive.

Next, the photoresist OFPR-800LB-200cp was applied to the film thickness gradient optical filter on the 2 cm square glass substrate by spin-coating at 3500 rpm for 30 seconds to form a photoresist film on an Ag film ((d) of FIG. 4).

### <Alignment of Photomask>

Using a mask aligner MA6 manufactured by SUSS MicroTec, alignment was performed such that the film thickness gradient optical filter attached to the 2 cm square glass substrate and a pixel region of a photomask coincide with each other, and exposure was performed. An exposure time was 20 seconds ((e) of FIG. 4).

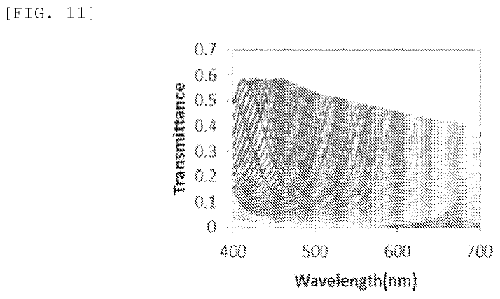

Here, for principle verification, disposition of pixels in the pixel region of the photomask was not random, and an equal interval shown in FIG. 9 was adopted. A pixel region size shown in FIG. 9 is smaller than a light receiving surface of S10420-1006-01 manufactured by Hamamatsu Photonics K.K. and can cover an entire inclination length of the film thickness gradient optical filter.

### <Development>

The film thickness gradient optical filter was immersed in NMD-3 (2.38% TMAH) at 26° C. for 90 seconds and then rinsed with pure water for 30 seconds twice for development ((f) of FIG. 4). After the development, the filter was dried by dry-spin for 180 seconds.

### <Milling>

With respect to the film thickness gradient optical filter after the development, a portion from which the photoresist was removed (non-pixelated region) was removed by ion beam milling for 10 minutes using IBE-KDC 75 manufactured by Hakuto Co., Ltd. ((g) of FIG. 4).

### <Removal of Residual Photoresist>

The photoresist remaining in the pixelated region was immersed in acetone for 5 minutes, rinsed once with IPA and removed, followed by natural drying ((h) of FIG. 4).

Thus, a spectral pixelated optical filter array was obtained.

### [Evaluation of Spectral Pixelated Optical Filter Array]

With respect to one pixel row (pixels disposed in a line in a film thickness gradient direction) of the spectral pixelated optical filter array obtained as described above, one pixel was selected for every two pixels as shown in FIG. 10, and each selected pixel was designated as p1, p2, p3, p4, . . . p14, p15, p16, and p17. The pixels p1 to p17 were subjected to a transmission measurement from a filter surface (Ag film side). As a result, it was confirmed that a peak wavelength linearly changed with respect to a pixel position. Further, the transmission measurement was performed from the filter surface (Ag film side) having a condition exceeding the pixel p17 (see FIG. 11).

### INDUSTRIAL APPLICABILITY

A spectral function-equipped imaging element according to the present invention can continuously and greatly increase the number of wavelength divisions and thus has an effect of improving clarity of an obtained image. Therefore, the spectral function-equipped imaging element according to the present invention can be mounted on and used in products in a wide range of industrial fields. Examples of the products and industrial fields to be applied to include an optical communication device, an optical measurement device, an optical information device (including an information terminal apparatus), an automobile, mobility, a satellite, a robot, a tracking system (device), and a wearable device. Examples of the information terminal apparatus include mobile terminal devices such as a small laptop, a smartphone, and a tablet terminal, a device for managing freshness or a taste factor of food, a device for managing color or quality, a printing device, a device for managing ink or paint, a cosmetic diagnosis device, and a device used in entertainment.

### REFERENCE SIGNS LIST

1: imaging element (image sensor)
2, 3, 4: spectral pixelated optical filter

1. A spectral function-equipped imaging element, wherein a plurality of spectral pixelated optical filters are incorporated, continuously in one direction of an imaging element without substantially influencing an imaging function of the imaging element, to enable acquisition of a spectrum of a target wavelength range.

2. The spectral function-equipped imaging element according to claim 1, wherein the plurality of spectral pixelated optical filters are incorporated, continuously in the one direction of the imaging element by replacing a part of pixelated color filters of the imaging element with the spectral pixelated optical filters, to enable the acquisition of the spectrum of the target wavelength range.

3. The spectral function-equipped imaging element according to claim 1, wherein the target wavelength range at least includes a wavelength range of 400 nm to 700 nm.

4. The spectral function-equipped imaging element according to claim 1, wherein each transmitted light wavelength of the plurality of spectral pixelated optical filters continuously disposed in the one direction is continuously shifted from one end to the other end in the one direction from a short wavelength side to a long wavelength side.

5. The spectral function-equipped imaging element according to claim 4, wherein each of the plurality of spectral pixelated optical filters continuously disposed in the one direction has a reflective layer A, an optical waveguide layer on the reflective layer A, and a reflective layer B on the optical waveguide layer, the plurality of spectral pixelated optical filters are continuously disposed in the one direction of an imaging surface, and a thickness of the optical waveguide layer continuously increases from the one end to the other end in the one direction.

6. The spectral function-equipped imaging element according to claim 5, wherein the reflective layer A and/or the reflective layer B is a layer containing a metal.

7. The spectral function-equipped imaging element according to claim 1, wherein the spectral pixelated optical filters are not adjacent to each other in a plan view of the spectral function-equipped imaging element from a side where the plurality of spectral pixelated optical filters are disposed.

8. A manufacturing method for a spectral pixelated optical filter array, the method comprising:
forming a reflective layer A on a transparent substrate, then disposing a mask above the reflective layer A at an interval from a surface of the reflective layer A and sputtering an optical waveguide layer forming material toward the surface of the reflective layer A, thereby forming, on the reflective layer A, an optical waveguide layer having an inclined portion whose thickness continuously increases toward one direction, and then forming a reflective layer B on the optical waveguide layer, thereby obtaining a film thickness gradient optical filter;
forming a photoresist film on the reflective layer B, then masking the photoresist film on the inclined portion corresponding to portions where a plurality of pixelated optical filters are to be formed, then exposing the photoresist film, and then removing the photoresist film of a portion not masked during the masking;
scraping off the film thickness gradient optical filter corresponding to the portion where the photoresist film is removed; and
removing the remaining photoresist film to obtain a spectral pixelated optical filter array in which a transmitted light wavelength is shifted from one end toward the other end in the one direction stepwise from a short wavelength side to a long wavelength side.

9. The manufacturing method for a spectral pixelated optical filter array according to claim 8, wherein spectral pixelated optical filters constituting the spectral pixelated optical filter array are not adjacent to each other in a plan view.

10. A manufacturing method a the spectral function-equipped imaging element comprising:
incorporating, in an imaging element, a pixelated optical filter array obtained by the manufacturing method for a spectral pixelated optical filter array according to claim 8.
wherein, into the spectral function-equipped imaging element, a plurality of spectral pixelated optical filters are incorporated, continuously in one direction of an imaging element without substantially influencing an imaging function of the imaging element, to enable acquisition of a spectrum of a target wavelength range.

11. The manufacturing method for a spectral function-equipped imaging element according to claim 10, wherein the plurality of spectral pixelated optical filters are incorporated, continuously in the one direction of the imaging element by replacing a part of pixelated color filters of the imaging element with the spectral pixelated optical filters, to enable the acquisition of the spectrum of the target wavelength range.

12. The manufacturing method for a spectral function-equipped imaging element according to claim 10, wherein the target wavelength range at least includes a wavelength range of 400 nm to 700 nm.

13. The manufacturing method for a spectral function-equipped imaging element according to claim 10, wherein each transmitted light wavelength of the plurality of spectral pixelated optical filters continuously disposed in the one direction is continuously shifted from one end to the other end in the one direction from a short wavelength side to a long wavelength side.

14. The manufacturing method for a spectral function-equipped imaging element according to claim 13, wherein each of the plurality of spectral pixelated optical filters continuously disposed in the one direction has a reflective layer A, an optical waveguide layer on the reflective layer A, and a reflective layer B on the optical waveguide layer, the plurality of spectral pixelated optical filters are continuously disposed in the one direction of an imaging surface, and a thickness of the optical waveguide layer continuously increases from the one end to the other end in the one direction.

15. The manufacturing method for a spectral function-equipped imaging element according to claim 14, wherein the reflective layer A and/or the reflective layer B is a layer containing a metal.

16. The manufacturing method for a spectral function-equipped imaging element according to claim 10, wherein the spectral pixelated optical filters are not adjacent to each other in a plan view of the spectral function-equipped imaging element from a side where the plurality of spectral pixelated optical filters are disposed.

17. A product comprising:
the spectral function-equipped imaging element according to claim 1.
